(19) United States
(12) Patent Application Publication
(10) Pub. No.: US 2023/0409993 A1
(43) Pub. Date: Dec. 21, 2023

(54) IDENTIFICATION OF SIMULATION-DRIVEN OPTIMIZED INDICATION AND WARNING (I&W) CUTOFFS FOR SITUATION-SPECIFIC COURSES OF ACTION

(71) Applicant: Raytheon Company, Waltham, MA (US)

(72) Inventors: Monica M. Jacobs, Denver, CO (US); Theresa A. Williams, McKinney, TX (US); Terry L. Keeney, Thornton, CO (US)

(21) Appl. No.: 17/748,858

(22) Filed: May 19, 2022

(51) Int. Cl. G06Q 10/06

(52) U.S. Cl. CPC G06Q 10/0631

(57) ABSTRACT

A method includes identifying one or more characteristics associated with a current operational environment. The method also includes identifying one or more simulated scenarios having one or more characteristics that are similar to or match the one or more characteristics associated with the current operational environment. The method further includes identifying one or more cutoff values associated with the one or more simulated scenarios and one or more recommended courses of action associated with the one or more simulated scenarios. The method also includes using the one or more cutoff values to generate at least one notification, where the at least one notification is associated with the current operational environment. In addition, the method includes presenting the one or more recommended courses of action to at least one user or a decision engine for initiation within the current operational environment.

### TECHNICAL FIELD

This disclosure is generally directed to operational planning systems. More specifically, this disclosure is directed to the identification of simulation-driven optimized indication and warning (I&W) cutoffs for situation-specific courses of action.

### BACKGROUND

Various systems exist where a human operator needs to make decisions on what course of action (COA) should be followed to deal with a particular situation or achieve a particular objective. For example, human operators overseeing military or other defense-related operations often need to make decisions on what courses of action to follow in order to achieve one or more specified tactical or strategic objectives. In these and other situations, it is often imperative that the human operators be provided with tools that help maximize the probability of mission success.

### SUMMARY

This disclosure relates to the identification of simulation-driven optimized indication and warning (I&W) cutoffs for situation-specific courses of action.

In a first embodiment, a method includes identifying one or more characteristics associated with a current operational environment. The method also includes identifying one or more simulated scenarios having one or more characteristics that are similar to or match the one or more characteristics associated with the current operational environment. The method further includes identifying one or more cutoff values associated with the one or more simulated scenarios and one or more recommended courses of action associated with the one or more simulated scenarios. The method also includes using the one or more cutoff values to generate at least one notification, where the at least one notification is associated with the current operational environment. In addition, the method includes presenting the one or more recommended courses of action to at least one user or a decision engine for initiation within the current operational environment.

In a second embodiment, an apparatus includes at least one processing device configured to identify one or more characteristics associated with a current operational environment. The at least one processing device is also configured to identify one or more simulated scenarios having one or more characteristics that are similar to or match the one or more characteristics associated with the current operational environment. The at least one processing device is further configured to identify one or more cutoff values associated with the one or more simulated scenarios and one or more recommended courses of action associated with the one or more simulated scenarios. The at least one processing device is also configured to use the one or more cutoff values to generate at least one notification, where the at least one notification is associated with the current operational environment. In addition, the at least one processing device is configured to initiate presentation of the one or more recommended courses of action to at least one user or a decision engine for initiation within the current operational environment.

In a third embodiment, a non-transitory computer readable medium contains instructions that when executed cause at least one processor to identify one or more characteristics associated with a current operational environment. The medium also contains instructions that when executed cause the at least one processor to identify one or more simulated scenarios having one or more characteristics that are similar to or match the one or more characteristics associated with the current operational environment. The medium further contains instructions that when executed cause the at least one processor to identify one or more cutoff values associated with the one or more simulated scenarios and one or more recommended courses of action associated with the one or more simulated scenarios. The medium also contains instructions that when executed cause the at least one processor to use the one or more cutoff values to generate at least one notification, where the at least one notification is associated with the current operational environment. In addition, the medium contains instructions that when executed cause the at least one processor to initiate presentation of the one or more recommended courses of action to at least one user or a decision engine for initiation within the current operational environment.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting the identification of simulation-driven optimized indication and warning (I&W) cutoffs for situation-specific courses of action according to this disclosure;

FIG. 2 illustrates an example device supporting the identification of simulation-driven optimized I&W cutoffs for situation-specific courses of action according to this disclosure;

FIG. 3 illustrates an example simulation process used to support the identification of simulation-driven optimized I&W cutoffs for situation-specific courses of action according to this disclosure;

FIG. 4 illustrates an example storage of simulation data supporting the identification of simulation-driven optimized I&W cutoffs for situation-specific courses of action according to this disclosure;

FIG. 5 illustrates an example selection process used to support the identification of simulation-driven optimized I&W cutoffs for situation-specific courses of action according to this disclosure;

FIGS. 6 and 7 illustrate example data flows used to support the identification of simulation-driven optimized I&W cutoffs for situation-specific courses of action according to this disclosure; and

FIGS. 8 and 9 illustrate example methods for the identification of simulation-driven optimized I&W cutoffs for situation-specific courses of action according to this disclosure.

### DETAILED DESCRIPTION

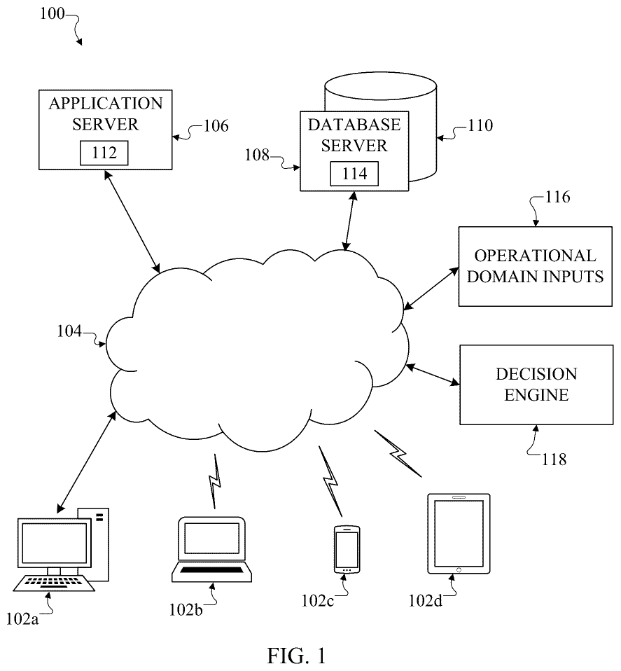

FIGS. 1 through 9, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

As noted above, various systems exist where a human operator needs to make decisions on what course of action (COA) should be followed to deal with a particular situation or achieve a particular objective. For example, human operators overseeing military or other defense-related operations often need to make decisions on what courses of action to follow in order to achieve one or more specified tactical or strategic objectives. In these and other situations, it is often imperative that the human operators be provided with tools that help maximize the probability of mission success.

Various approaches have been developed to automatically identify and provide potential courses of action to human operators for selection or implementation. However, these approaches can suffer from various shortcomings. For example, these approaches are often not suitable for use in the space domain or other time-dependent domains. The space domain typically involves courses of action that are associated with systems in space. In that domain, objects (such as satellites or other systems) can move at extremely high speeds, and the locations of the objects in space relative to other ground-, air-, water-, or space-based locations can change rapidly. In this domain or other highly time-dependent domains, the identification of recommended courses of action for a given situation can be important in order to allow human operators to make the best possible decisions, ideally without extensive operator training and experience. Unfortunately, since the validity of these recommended courses of action may be highly time-dependent, indications and warnings that are based on static thresholds or other static values may alert human operators too late for optimal courses of action to be initiated, which can significantly decrease the probability of mission success.

This disclosure provides various techniques related to the identification of simulation-driven optimized indication and warning (I&W) cutoffs for situation-specific courses of action. Indications and warnings generally refer to notifications that are presented to human operators, and cutoff values generally refer to criteria that need to be met in order for specific indications and warnings to be presented to human operators. The indications and warnings are typically used by the human operators to determine whether courses of action need to be initiated and to select and initiate the appropriate courses of action.

As described in more detail below, an optimization framework is provided and configured to run various simulations using data that is collected ahead of time. In some cases, for example, the simulations can be run for a diverse set of threats or other operational situations that human operators might experience and for which the human operators might need to select appropriate countermeasures or other courses of action. The simulations allow the optimization framework to identify optimal applications of potential courses of action to the various operational situations. The simulations also allow the optimization framework to identify optimal cutoff values for the indications and warnings used by the human operators to decide when courses of action should be initiated. Later, data associated with a real-world operational environment may be obtained, where the real-world operational environment represents an actual environment for which at least one human operator actually needs to initiate one or more courses of action. The data associated with the real-world operational environment can be used to identify similar simulated scenarios, select one or more appropriate courses of action, and select one or more cutoff values for one or more indications or warnings associated with the one or more selected courses of action.

In this way, the techniques described in this patent disclosure enable the identification of situational courses of action, such as courses of action that are optimized for use under specific real-world operational conditions. Moreover, the cutoff values for the indications or warnings that are selected can be optimized for specific real-world operational environments. This allows for the selection and application of dynamically-changing criteria when determining which cutoff values should be used to generate and present indications and warnings to human operators.

Note that, for ease of explanation, the techniques described in this patent disclosure are often described with reference to use in identifying and initiating courses of action that are available in the space domain. However, the techniques described in this patent disclosure may be used to support indication or warning cutoff value selection and course of action identification in any other suitable domain. For example, these techniques may be used in any domain where a human operator needs to be notified of an activity or other condition in order to optimize subsequent decisions by the human operator. As a particular example, these techniques may be used with any time-sensitive decisions that are based on dynamic input and that require thresholded output.

Also note that there are various commercial and defense-related applications for the techniques described in this patent disclosure. With respect to defense-related applications, the techniques described in this patent disclosure may be useful in applications such as management of multi-domain warfare, which refers to warfare that spans multiple tactical domains (like two or more ground, air, sea, space, or cyberspace domains). The complexities of multi-domain warfare with adversaries can overwhelm a human decision-maker's ability to rapidly identify, select, and initiate appropriate courses of action. With respect to commercial applications, the techniques described in this patent disclosure may be useful in applications that involve planning the usage of assets spread across one or more domains, which can similarly overwhelm a human decision-maker's ability to rapidly identify, select, and initiate appropriate courses of action in order to achieve desired objectives.

FIG. 1 illustrates an example system 100 supporting the identification of simulation-driven optimized indication and warning (I&W) cutoffs for situation-specific courses of action according to this disclosure. As shown in FIG. 1, the system 100 includes multiple user devices 102a-102d, at least one network 104, at least one application server 106, and at least one database server 108 associated with at least one database 110. Note, however, that other combinations and arrangements of components may also be used here.

In this example, each user device 102a-102d is coupled to or communicates over the network 104. Communications between each user device 102a-102d and a network 104 may occur in any suitable manner, such as via a wired or wireless connection. Each user device 102a-102d represents any suitable device or system used by at least one user to provide information to the application server 106 or database server 108 or to receive information from the application server 106 or database server 108. Any suitable number(s) and type(s) of user devices 102a-102d may be used in the system 100. In this particular example, the user device 102a represents a desktop computer, the user device 102b represents a laptop computer, the user device 102c represents a smartphone, and the user device 102d represents a tablet computer. However, any other or additional types of user devices may be used in the system Each user device 102a-102d includes any suitable structure configured to transmit and/or receive information.

The network 104 facilitates communication between various components of the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. The network 104 may also operate according to any appropriate communication protocol or protocols.

The application server 106 is coupled to the network 104 and is coupled to or otherwise communicates with the database server 108. The application server 106 supports the execution of one or more applications 112, which can implement various inventive features of the system 100. For example, the one or more applications 112 can be executed in order to provide an optimization framework. The optimization framework can perform various simulations using collected data in order to generate various information 114 that is stored in the database 110 via the database server 108. The information 114 here can include information associated with the simulations, such as information identifying recommended courses of action and information identifying optimal indication and warning cutoff values to be used with those courses of action. For instance, the indication and warning cutoff values may be generated based on the simulations and designed to give human operators adequate, optimal, or maximum time to determine whether the associated courses of action should be initiated.

Subsequently, the one or more applications 112 may receive various operational domain inputs 116, which represent data defining at least one actual operational environment in which courses of action may need to be initiated and performed. The one or more applications 112 can use the operational domain inputs 116 to select the simulated scenario or scenarios that are most similar to an actual operational environment, and the one or more applications 112 can identify one or more indication/warning cutoff values to be used for that actual operational environment and one or more possible courses of action that may be initiated and performed in the actual operational environment. The one or more indication/warning cutoff values can then be used to control if and when at least one indication or warning is presented to one or more human operators (such as via one or more user devices 102a-102d), and the one or more possible courses of action may be presented to one or more human operators for initiation (such as after the associated indication or warning has actually been triggered). In some cases, the indication/warning cutoff value(s) associated with a single simulated scenario may be selected and used. In other cases, the indication/warning cutoff values associated with multiple simulated scenarios may be selected and processed (such as by averaging or interpolation) to generate at least one indication/warning, cutoff value that is used.

The one or more applications 112 may also or alternatively use the operational domain inputs 116 to select the simulated scenario or scenarios that are most similar to an actual operational environment, and the one or more applications 112 can identify one or more indication/warning cutoff values to be used for that actual operational environment and one or more possible courses of action that may be initiated and performed in the actual operational environment. The one or more indication/warning cutoff values can then be used to control if and when at least one indication or warning is generated, and the one or more possible courses of action associated with the at least one indication or warning may be presented to the decision engine 118 (possibly along with or separate from the at least one indication or warning). The decision engine 118 represents a system that can determine whether to initiate or perform the one or more possible courses of action associated with the at least one indication or warning, with or without human intervention or approval. For example, the decision engine 118 may use one or more confidence levels associated with the indication(s), warning(s), or course(s) of action to determine whether to initiate or perform the course(s) of action. The decision engine may use any suitable logic to determine whether to initiate or perform one or more courses of action, such as a trained machine learning model, other artificial intelligence system, or other system. Note that the decision engine 118 here is shown as being separate from the application server 106, and the decision engine 118 may communicate with the application server 106 or otherwise receive information associated with indications, warnings, or courses of action locally or over one or more communication networks. In other cases, the functionality of the decision engine 118 may be implemented in the application server 106.

The database server 108 operates to store and facilitate retrieval of various information used, generated, or collected by the application server 106 and the user devices 102a-102d in the database 110. For example, the database server 108 may store various information in relational database tables or other data structures in the database 110. Note, however, that the database server 108 may be used within the application server 106 to store information in other embodiments, in which case the application server 106 may store the information 114 itself.

Although FIG. 1 illustrates one example of a system 100 supporting the identification of simulation-driven optimized I&W cutoffs for situation-specific courses of action, various changes may be made to FIG. 1. For example, the system 100 may include any number of user devices 102a-102d, networks 104, application servers 106, database servers databases 110, and decision engines 118. Also, these components may be located in any suitable locations and might be distributed over a large area. In addition, while FIG. 1 illustrates one example operational environment in which the identification of simulation-driven optimized indication and warning cutoffs for situation-specific courses of action may be used, this functionality may be used in any other suitable system. For instance, it is possible for applications 112 in different servers 106 or other devices to be used, such as when one or more applications 112 executed by one or more devices provide the optimization framework for performing the simulations and one or more other applications 112 executed by one or more other devices use the simulation results to identify the I&W cutoff values that are used and the courses of action that are recommended for actual operational environments,

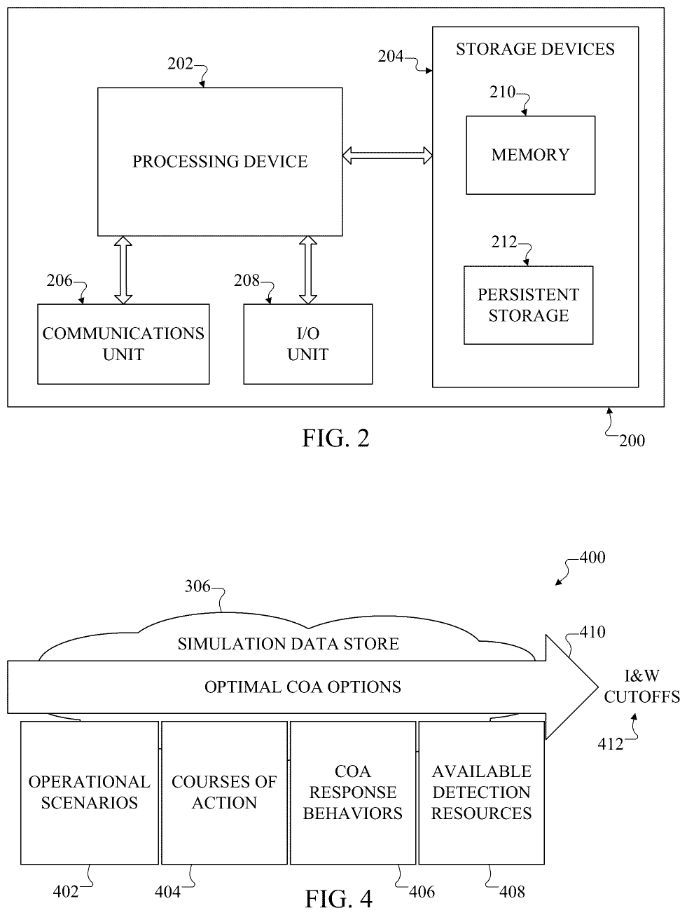

FIG. 2 illustrates an example device 200 supporting the identification of simulation-driven optimized I&W cutoffs for situation-specific courses of action according to this disclosure. One or more instances of the device 200 may, for example, be used to at least partially implement the functionality of the application server 106 of FIG. 1. However, the functionality of the application server 106 may be implemented in any other suitable manner. In some embodiments, the device 200 shown in FIG. 2 may form at least part of a user device 102a-102d, application server 106, database server 108, or decision engine 118 in FIG. 1. However, each of these components may be implemented in any other suitable manner.

As shown in FIG. 2, the device 200 denotes a computing device or system that includes at least one processing device 202, at least one storage device 204, at least one communications unit 206, and at least one input-′output (I/O) unit 208. The processing device may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis), The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network. The communications unit 206 may support communications through any suitable physical or wireless communication link(s). As a particular example, the communications unit 206 may support communication over the network(s) 104 of FIG. 1.

The I/O unit 208 allows for input and output of data. For example, the I/O unit 208 may provide a connection for user input, through a keyboard, mouse, keypad, touchscreen, or other suitable input device. The I/O unit 208 may also send output to a display, printer, or other suitable output device. Note, however, that the I/O unit 208 may be omitted if the device 200 does not require local I/O, such as when the device 200 represents a server or other device that can be accessed remotely.

In some embodiments, the instructions executed by the processing device 202 include instructions that implement the functionality of the application server 106. For example, the instructions executed by the processing device 202 may provide an optimization framework that run simulations and identifies optimal cutoff values for indications and warnings. The instructions executed by the processing device 202 may also use operational domain inputs 116 to select simulated scenarios most similar to existing operational scenarios, identify recommended courses of action, and identify (or possibly generate) optimal I&W cutoff values. As noted above, however, it is also possible for different devices to provide the optimization framework and to receive and use the operational domain inputs 116.

Although FIG. 2 illustrates one example of a device 200 supporting the identification of simulation-driven optimized I&W cutoffs for situation-specific courses of action, various changes may be made to FIG. 2. For example, computing and communication devices and systems come in a wide variety of configurations, and FIG. 2 does not limit this disclosure to any particular computing or communication device or system.

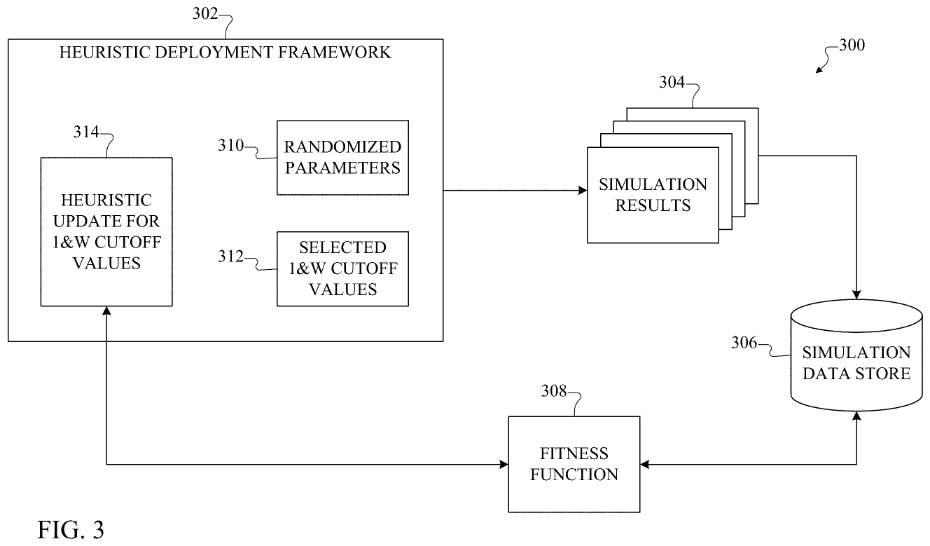

FIG. 3 illustrates an example simulation process 300 used to support the identification of simulation-driven optimized I&W cutoffs for situation-specific courses of action according to this disclosure. For ease of explanation, the simulation process 300 of FIG. 3 may be described as being implemented using one or more applications 112 executed by the application server 106 of FIG. 1, where the application server 106 can be implemented using one or more devices 200 of FIG. 2. However, the simulation process may be implemented using any other suitable device(s) and in any other suitable system(s).

As shown in FIG. 3, the simulation process 300 involves the use of a heuristic deployment framework 302, which represents an optimization framework that can perform various simulations and identify optimal parameters associated with the simulations. More specifically, the heuristic deployment framework 302 here can perform various Monte Carlo simulations or other simulations to generate simulation results 304. The simulation results 304 or information based on the simulation results 304 can be stored in a simulation data store 306, which may represent the database 110 of FIG. 1. The simulation results 304 can also be scored using a fitness function 308, which can evaluate the simulation results 304 in order to allow for comparisons of different simulations. Scoring of the simulation results 304 can be fed back to the heuristic deployment framework 302 for consideration, such as to design additional simulations and generate additional simulation results 304.

In this example, the heuristic deployment framework 302 can generate or otherwise obtain randomized parameters 310, which represent different possible parameters of an operational environment where one or more courses of action might need to be initiated and performed. For example, the randomized parameters 310 can represent values that may be received in the operational domain inputs 116. The heuristic deployment framework 302 can also generate or otherwise obtain selected I&W cutoff values 312, which represent possible cutoff values that may be used during simulations. Collectively, the randomized parameters and the I&W cutoff values 312 can define at least some of the parameters that are used during one or more Monte Carlo simulations or other simulations. For instance, the randomized parameters 310 can represent a random operational environment where usage of one or more courses of action can be simulated, and the I&W cutoff values 312 can represent one or more cutoff values to be used within the random operational environment. The heuristic deployment framework 302 can run one or more simulations and generate one or more sets of simulation results 304 using the randomized parameters 310 and the I&W cutoff values 312.

As a particular example of this, the heuristic deployment framework 302 may select a single set of I&W cutoff values 312 (meaning one or more specific cutoff values for one or more specific indications or warnings) and run a number of simulations. These simulations can be performed using that set of I&W cutoff values 312 and different randomized parameters 310 representing a number of possible operational environments. This allows the heuristic deployment framework 302 to simulate how effective various courses of action might be under different operational scenarios when that set of I&W cutoff values 312 is used to simulate the generation of notifications for human operators. This procedure can be repeated with different sets of I&W cutoff values 312, which allows the heuristic deployment framework 302 to simulate how the usage of different I&W cutoff values 312 can affect the initiation and use of various courses of action under different operational scenarios.

The scoring by the fitness function 308 can provide valuable feedback to the heuristic deployment framework 302. For example, the fitness function 308 here may generate scores that indicate how effective different courses of action are in meeting one or more objectives during the simulations. Among other things, this scoring allows the heuristic deployment framework 302 to determine which courses of action may be more or most useful in achieving one or more objectives under different simulated scenarios. This information can later be used to recommend courses of action to human operators for real-world operational scenarios. This scoring also allows a heuristic update function 314 of the heuristic deployment framework 302 to determine how the I&W cutoff values 312 might be modified to produce improved results. For instance, the heuristic update function 314 can update the I&W cutoff values 312 being used during simulations, and the updated I&W cutoff values 312 can be used to produce additional simulation results 304 that are scored. The I&W cutoff values 312 determined to provide improved or optimal results may be identified as being more or most useful in achieving one or more objectives under different simulated scenarios. This information can later be used to select which I&W cutoff values 312 should be used to generate notifications for human operators for real-world operational scenarios.

The heuristic deployment framework 302 may use any suitable technique to generate or otherwise obtain the randomized parameters 310. For example, in some embodiments, the heuristic deployment framework 302 may receive information identifying real-world or estimated/simulated conditions in a given operational environment, and the heuristic deployment framework 302 may vary those conditions in the given operational environment in order to produce a collection of conditions. The heuristic deployment framework 302 may then select random combinations of the conditions from the collection in order to produce different sets of randomized parameters 310. The heuristic deployment framework 302 may also use any suitable technique to generate or otherwise obtain the I&W cutoff values 312. For instance, in some embodiments, the heuristic deployment framework may receive information identifying ranges of possible cutoff values for different indications and warnings, and the heuristic deployment framework 302 may then select random combinations of values within the ranges in order to produce different sets of I&W cutoff values 312. Further, the heuristic update function 314 may use any suitable technique to modify the I&W cutoff values 312. For example, in some embodiments, the heuristic update function may be configured to modify one or more cutoff values 312 each by a specified amount or percentage or within a specified amount or percentage and determine how the modifications affect the scoring of the simulation results 304 produced using the modified cutoff value(s) The heuristic update function 314 can identify improvements in one or more cutoff values over time based on a number of simulations and associated scoring. In addition, the scoring function 308 may use any suitable technique to score the simulation results 304, such as a function that scores the simulation results 304 based on how well one or more objectives or other criteria are satisfied while minimizing one or more other criteria.

In some embodiments, the end result of the simulation process 300 is a data store that contains information regarding a large number of simulated scenarios. For example, the data store 306 may store information identifying the parameters 310 used for numerous simulations. The data store 306 may also store information identifying the course(s) of action that may be recommended for use as determined for each of the simulations. The data store may further store information identifying the I&W cutoff value(s) 312 that should be used to generate at least one indication or warning as determined for each of the simulations. As described in more detail below, when operational domain inputs 116 associated with an actual operational environment are received, the operational domain inputs 116 may be matched to one or more simulated scenarios, and the identified course(s) of action and the identified I&W cutoff value(s) 312 for the one or more matched simulated scenarios may be used for that actual operational environment.

Although FIG. 3 illustrates one example of a simulation process 300 used to support the identification of simulation-driven optimized I&W cutoffs for situation-specific courses of action, various changes may be made to FIG. 3. For example, various functions can be added, omitted, combined, further subdivided, replicated, or placed in any other suitable configuration in the simulation process 300 according to particular needs.

FIG. 4 illustrates an example storage 400 of simulation data supporting the identification of simulation-driven optimized I&W cutoffs for situation-specific courses of action according to this disclosure. For ease of explanation, the storage 400 of FIG. 4 may be described as being implemented using one or more applications 112 executed by the application server 106 of FIG. 1, where the application server 106 can be implemented using one or more devices 200 of FIG. 2. However, the storage 400 may be implemented using any other suitable device(s) and in any other suitable system(s).

As shown in FIG. 4, the data store 306 here can store information related to operational scenarios 402, which represent scenarios that might be encountered by human operators in real-world situations. The operational scenarios 402 may, for example, be defined based on the various sets of randomized parameters 310 used to generate the simulation results 304. The data store 306 can also store courses of action 404, which represent possible actions that may be initiated by the human operators in real-world situations. The courses of action 404 may, for instance, be defined based on information identifying the types of actions that human operators can initiate in one or more situations. The data store 306 can further store possible COA response behaviors 406, which represent possible actions that an adversary might take or that might otherwise be triggered for each course of action 404. The possible COA response behaviors 406 may, for example, be defined based on information identifying known response characteristics or known capabilities of an adversary. In addition, the data store 306 here can store information identifying available detection resources 408, which represent one or more sources of data (such as one or more data sources that can provide operational domain inputs 116). The available detection resources 408 may, for instance, be defined based on information identifying known sensors or other data sources that can provide inputs used to identify a specific operational scenario or how an adversary actually responds to one or more courses of action that are performed.

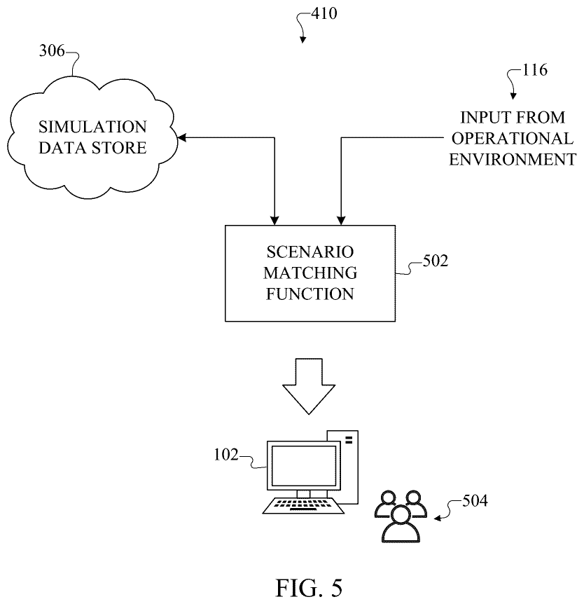

Using these or other types of information, a selection process 410 may be used to identify (among other things) one or more I&W cutoff values to be used with an actual operating environment. The selection process 410 may also be used to recommend one or more courses of action based on the actual operating environment. The selection process 410 is described in more detail below with reference to FIG. 5.

Although FIG. 4 illustrates one example of a storage 400 of simulation data supporting the identification of simulation-driven optimized I&W cutoffs for situation-specific courses of action, various changes may be made to FIG. 4. For example, the data shown in FIG. 4 may be combined or subdivided in any other suitable manner.

FIG. 5 illustrates an example selection process 410 used to support the identification of simulation-driven optimized I&W cutoffs for situation-specific courses of action according to this disclosure. For ease of explanation, the selection process 410 of FIG. 4 may be described as being implemented using one or more applications 112 executed by the application server 106 of FIG. 1, where the application server 106 can be implemented using one or more devices 200 of FIG. 2. However, the selection process 410 may be implemented using any other suitable device(s) and in any other suitable system(s).

As shown in FIG. 5, the selection process 410 involves the use of the operational domain inputs 116, which can define one or more characteristics of an actual operational environment where one or more courses of action may need to be initiated and performed. The selection process 410 also involves the use of the simulation data store 306, which may include the various types of data shown in FIG. 4 related to simulated scenarios.

A scenario matching function 502 generally operates to match the actual operational environment to one or more of the simulated scenarios associated with the data store 306. For example, the scenario matching function 502 may identify one or more simulated scenarios having one or more characteristics that most closely match the characteristics of the actual operational environment as identified by or derived from the operational domain inputs 116. The scenario matching function 502 can then identify one or more courses of action that may be recommended and one or more I&W cutoff values associated with the one or more identified courses of action based on the matching simulated scenario(s).

As a particular example of this, the scenario matching function 502 may search the data store 306 for one or more simulated scenarios that best match the actual operational environment. Assuming one or more simulated scenarios are located in the data store 306, the scenario matching function 502 can identify one or more courses of action identified by the one or more located simulated scenarios as being more or most useful. The scenario matching function 502 can also identify which of the identified courses of action might benefit from early operator notification and identify the I&W cutoff value(s) for one or more courses of action that can benefit from early operator notification.

The scenario matching function 502 can output (among other things) one or more courses of action that are recommended given the actual operational environment and one or more I&W cutoff values for those one or more courses of action. This information is used in this example in conjunction with at least one user device 102 associated with one or more users 504. For example, the one or more I&W cutoff values may be used to produce notifications (indications or warnings) that can be presented on the display(s) of the user device(s) 102. The one or more courses of action may also be presented on the display(s) of the user device(s) 102 so that the one or more users 504 can review and (if desired) initiate any of the course(s) of action. Also or alternatively, courses of action (with or without the associated notifications) may be provided to the decision engine 118 for consideration and possible invocation or performance. The one or more courses of action may typically be presented to the user(s) 504 or otherwise used after an indication or warning is triggered using the associated I&W cutoff value. Ideally, the use of the one or more I&W cutoff values that are determined as described above can result in dynamically-recommended courses of action that are presented at the earliest or optimal times to the user(s) 504 or the decision engine 118.

In this way, it is possible for a system to recommend courses of action to be performed under different operational scenarios and to dynamically update the indication and warning cutoff values based on the recommend courses of action to be performed. In some cases, this can be viewed as coupling the indication and warning cutoff values to the recommend courses of action. Moreover, since a large number of simulations can be performed and a large amount of data for simulated scenarios can be stored in the data store 306, it is possible to use the simulated scenarios to establish patterns that can be adapted for new adversarial systems or other systems coming online in an environment. In other words, it is possible to use the simulated scenarios to identify recommended courses of action and indication and warning cutoff values to be used even with new systems based on the new systems' similarities with simulated scenarios. In addition, in some cases, the scenario matching function 502 may operate as a background service or other background function that can dynamically select and update courses of action and indication and warning cutoff values as conditions in an operational domain change. Overall, these types of functionalities can help enable the system to be used with fast-paced or highly-time dependent operational environments, such as in the space domain or other domain.

Although FIG. 5 illustrates one example of a selection process 410 used to support the identification of simulation-driven optimized I&W cutoff's for situation-specific courses of action, various changes may be made to FIG. 5. For example, various functions can be added, omitted, combined, further subdivided, replicated, or placed in any other suitable configuration in the selection process 410 according to particular needs,

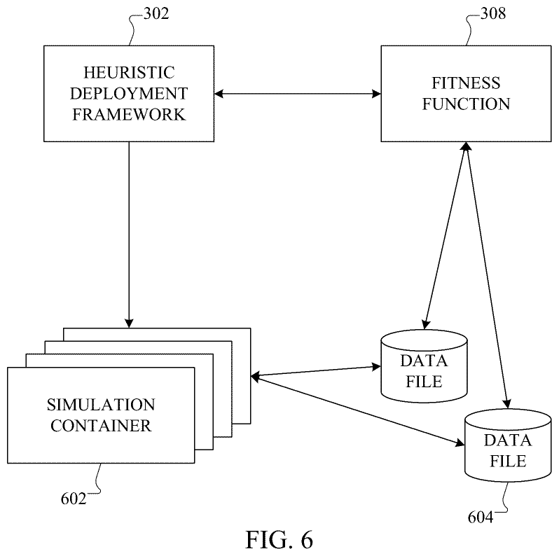

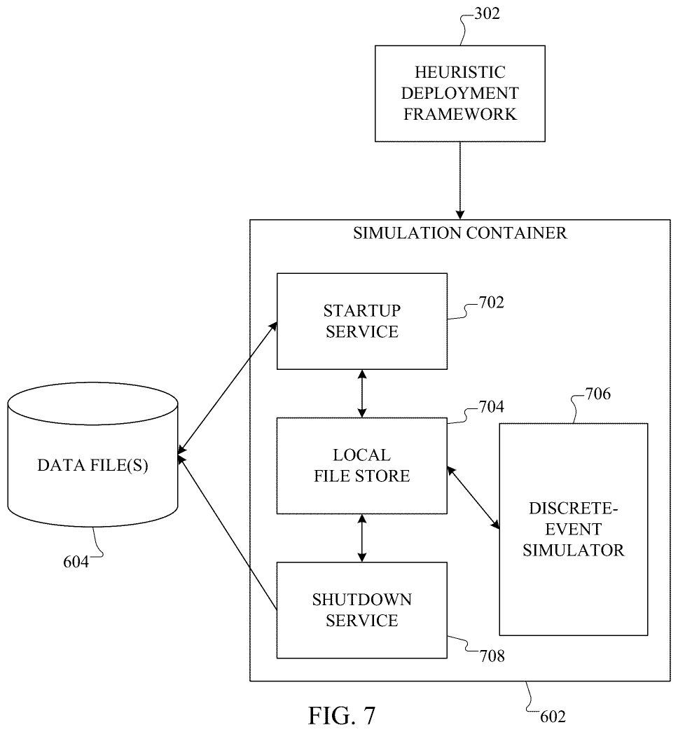

FIGS. 6 and 7 illustrate example data flows used to support the identification of simulation-driven optimized I&W cutoffs for situation-specific courses of action according to this disclosure. More specifically, FIG. 6 illustrates one example of data flows used by the heuristic deployment framework 302 during simulations, and FIG. 7 illustrates one example of data flows used with a simulation container during a simulation.

As shown in FIG. 6, the heuristic deployment framework 302 can generate or operate in conjunction with multiple simulation containers 602, where each simulation container 602 is associated with one simulation being performed. The simulation containers can interact with various data files 604, which can be used to store information used during the simulations and to store the results of the simulations. The results of the simulations can be provided to the fitness function 308 for scoring, and the scores are provided to the heuristic deployment framework 302 as feedback (such as to enable modification of I&W cutoff values 312).

As shown in FIG. 7, each simulation container 602 includes or is associated with a startup service 702, a local file store 704, a discrete-event simulator or other simulation function 706, and a shutdown service 708. The startup service 702 can read information from one or more data files 604, such as randomized parameters 310, I&W cutoff values 312, and other values to be used during a simulation. This information can be stored in the local file store 704, and the simulation function 706 can use this information to perform a simulation. The results of the simulation can be stored by the simulation function 706 in the local file store 704, and the results of the simulation can be transferred from the local file store 704 to one or more data files 604 by the shutdown service 708. The simulation function 706 can support any suitable type of simulation functionality, and the simulation function 706 may represent an Advanced Framework for Simulation, Integration and Modeling (AFSIM) function in some cases.

Although FIGS. 6 and 7 illustrate examples of data flows used to support the identification of simulation-driven optimized I&W cutoffs for situation-specific courses of action, various changes may be made to FIGS. 6 and 7. For example, any other suitable data flows may be used during simulations to identify optimized I&W cutoff values. Also, the use of “containerized” simulations is optional, and other approaches for performing the simulations may be used.

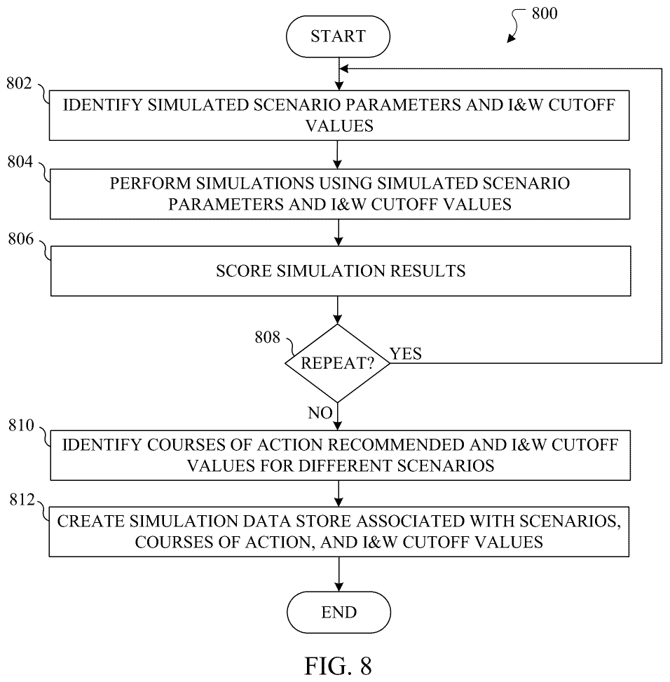

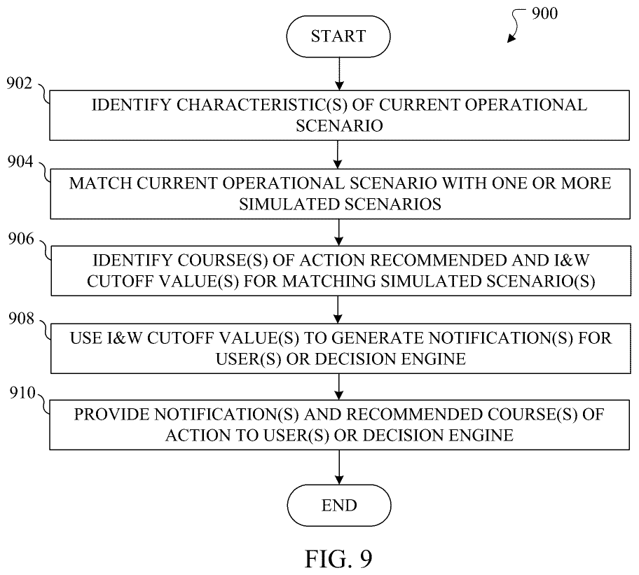

FIGS. 8 and 9 illustrate example methods 800 and 900 for the identification of simulation-driven optimized I&W cutoffs for situation-specific courses of action according to this disclosure. For ease of explanation, each method 800 and 900 may be described as being performed by one or more applications 112 executed by the application server 106 of FIG. 1, where the application server 106 can be implemented using one or more devices 200 of FIG. 2, However, each method 800 and 900 may be performed by any other suitable device(s) and used in any other suitable system(s).

As shown in FIG. 8, simulated scenario parameters and I&W cutoff values are identified at step 802. This may include, for example, the processing device 202 of the application server 106 identifying randomized parameters 310 associated with different simulated operational environments and identifying potential I&W cutoff values 312 to be used with the simulated operational environments. Simulations are performed using the simulated scenario parameters and the I&W cutoff values at step 804, and the simulation results are scored at step 806. This may include, for example, the processing device 202 of the application server simulating how various courses of action might be used in the simulated operational environments. As part of these simulations, this may include the heuristic deployment framework 302 simulating how notifications (indications and warnings) for users or a decision engine can be generated using the I&W cutoff values 312 and how the timing of those notifications can impact the effectiveness of the courses of action. This may also include the processing device 202 of the application server 106 scoring the results of the simulations. A determination is made whether to repeat these operations at step 808. This may include, for example, the processing device 202 of the application server 106 determining whether a specified number of iterations have been performed or whether some optimization threshold has been satisfied. This supports the use of an iterative process, where the scores of prior simulation results are used to conduct additional simulations that are scored.

One or more courses of action to be recommended for each simulated scenario and one or more I&W cutoff values to be used with each simulated scenario are identified at step 810. This may include, for example, the processing device 202 of the application server 106 selecting one or more courses of action for each simulated scenario, where the selected course(s) of action may provide satisfactory or optimal results (such as by satisfying one or more objectives). This may also include the processing device 202 of the application server identifying one or more I&W cutoff values associated with the course(s) of action selected for each simulated scenario. A simulation data store associated with the simulated scenarios, courses of action, and I&W cutoff values is created at step 812. This may include, for example, the processing device 202 of the application server 106 storing information identifying the simulated scenarios, the recommended courses of action, and the I&W cutoff values selected for the simulated scenarios in the database 110.

As shown in FIG. 9, one or more characteristics of a current operational environment are identified at step 902. This may include, for example, the processing device of the application server 106 receiving operational domain inputs 116 identifying characteristics of a current operational environment in which one or more users or a decision engine may need to initiate one or more courses of action. The current operational environment is matched with one or more simulated scenarios at step 904. This may include, for example, the processing device 202 of the application server 106 accessing the data store 306 and identifying any simulated scenarios that have parameters 310 matching or similar to the characteristics of the current operational environment (such as parameters matchings to within threshold amounts or percentages). Depending on the implementation and the current operational environment, there may be one matching simulated scenario or multiple simulated scenarios that are identified here.

One or more courses of action and one or more I&W cutoff values are identified using the matched simulated scenario(s) at step 906. This may include, for example, the processing device 202 of the application server 106 identifying one or more courses of action and one or more WV cutoff values from the data store 306 that are associated with the one or more matching simulated scenarios. If a single matching simulated scenario is identified, the course(s) of action and the I&W cutoff value(s) may be associated with that single simulated scenario. If multiple matching simulated scenarios are identified, the courses of action and the I&W cutoff values for the matching simulated scenarios may be processed, such as by aggregating the courses of action and averaging or interpolating the I&W cutoff values. In some cases, the one or more courses of action can include one or more actions to be performed using one or more space-based assets, such as one or more satellites or other space-based vehicles.

The one or more identified WV cutoff values may be used to generate one or more notifications for one or more users or a decision engine at step 908, and the one or more notifications and the one or more recommended courses of action can be presented to the user(s) or the decision engine at step 910. This may include, for example, the processing device of the application server 106 providing the identified I&W cutoff value(s) to at least one user device 102 for use in determining (based on information related to the current operational environment) if and when one or more notifications should be provided to one or more users or the decision engine 118. This may also include the processing device 202 of the application server 106 providing the identified course(s) of action to the at least one user device 102 for presentation and optional invocation by the user(s) or to the decision engine 118 if and when a notification is generated. Note that the application server 106 may also use the identified I&W cutoff value(s) and course(s) of action or provide the identified I&W cutoff value(s) and course(s) of action to another component for use in this manner or any other suitable manner. Note that this can also be an iterative process, where updated characteristics of the current operational environment are used to dynamically update the I&W cutoff values and the recommended courses of action.

Although FIGS. 8 and 9 illustrate examples of methods 800 and 900 for the identification of simulation-driven optimized I&W cutoffs for situation-specific courses of action, various changes may be made to FIGS. 8 and 9. For example, while each figure shows as a series of steps, various steps in each figure may overlap, occur in parallel, occur in a different order, or occur any number of times. Also, while the methods 800 and 900 have been described as being performed using the same device (the application server 106), the methods 800 and 900 may be separately implemented and used together in other implementations.

The following describes example embodiments of this disclosure that implement or relate to the identification of simulation-driven optimized indication and warning (I&W) cutoffs for situation-specific courses of action. However, other embodiments may be used in accordance with the teachings of this disclosure.

In a first embodiment, a method includes identifying one or more characteristics associated with a current operational environment. The method also includes identifying one or more simulated scenarios having one or more characteristics that are similar to or match the one or more characteristics associated with the current operational environment. The method further includes identifying one or more cutoff values associated with the one or more simulated scenarios and one or more recommended courses of action associated with the one or more simulated scenarios. The method also includes using the one or more cutoff values to generate at least one notification, where the at least one notification is associated with the current operational environment. In addition, the method includes presenting the one or more recommended courses of action to at least one user or a decision engine for initiation within the current operational environment.

In a second embodiment, an apparatus includes at least one processing device configured to identify one or more characteristics associated with a current operational environment. The at least one processing device is also configured to identify one or more simulated scenarios having one or more characteristics that are similar to or match the one or more characteristics associated with the current operational environment. The at least one processing device is further configured to identify one or more cutoff values associated with the one or more simulated scenarios and one or more recommended courses of action associated with the one or more simulated scenarios. The at least one processing device is also configured to use the one or more cutoff values to generate at least one notification, where the at least one notification is associated with the current operational environment. In addition, the at least one processing device is configured to initiate presentation of the one or more recommended courses of action to at least one user or a decision engine for initiation within the current operational environment.

In a third embodiment, a non-transitory computer readable medium contains instructions that when executed cause at least one processor to identify one or more characteristics associated with a current operational environment. The medium also contains instructions that when executed cause the at least one processor to identify one or more simulated scenarios having one or more characteristics that are similar to or match the one or more characteristics associated with the current operational environment. The medium further contains instructions that when executed cause the at least one processor to identify one or more cutoff values associated with the one or more simulated scenarios and one or more recommended courses of action associated with the one or more simulated scenarios. The medium also contains instructions that when executed cause the at least one processor to use the one or more cutoff values to generate at least one notification, where the at least one notification is associated with the current operational environment. In addition, the medium contains instructions that when executed cause the at least one processor to initiate presentation of the one or more recommended courses of action to at least one user or a decision engine for initiation within the current operational environment.

Any single one or any suitable combination of the following features may be used with the first, second, or third embodiment. The one or more recommended courses of action may be presented or presentation of the one or more recommended courses of action may be initiated in response to determining that at least one of the one or more cutoff values has triggered the at least one notification. At least one of the one or more cutoff values or at least one of the one or more recommended courses of action may be dynamically updated based on one or more updated characteristics associated with the current operational environment. Simulations may be performed for multiple simulated scenarios to identify, for each simulated scenario, at least one recommended course of action and at least one cutoff value. The simulations may be performed by obtaining parameters defining each of the simulated scenarios, simulating use of different courses of action for each of the simulated scenarios using different selected cutoff values to generate different simulation results for each simulated scenario, and scoring the simulation results to identify one or more optimal courses of action and one or more optimal cutoff values for each of the simulated scenarios. The simulations may further be performed by modifying the selected cutoff values based on the scoring to produce updated cutoff values and simulating use of the different courses of action for each of the simulated scenarios using the updated cutoff values. The current operational environment may represent a space environment, and the one or more recommended courses of action may be associated with one or more actions by at least one space-based vehicle.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
identifying one or more characteristics associated with a current operational environment;
identifying one or more simulated scenarios having one or more characteristics that are similar to or match the one or more characteristics associated with the current operational environment;
identifying one or more cutoff values associated with the one or more simulated scenarios and one or more recommended courses of action associated with the one or more simulated scenarios;
using the one or more cutoff values to generate at least one notification, the at least one notification associated with the current operational environment, and
presenting the one or more recommended courses of action to at least one user or a decision engine for initiation within the current operational environment.

2. The method of claim 1, wherein the one or more recommended courses of action are presented in response to determining that at least one of the one or more cutoff values has triggered the at least one notification.

3. The method of claim 1, further comprising:
dynamically updating at least one of the one or more cutoff values or at least one of the one or more recommended courses of action based on one or more updated characteristics associated with the current operational environment.

4. The method of claim 1, further comprising:
performing simulations for multiple simulated scenarios to identify, for each simulated scenario, at least one recommended course of action and at least one cutoff value.

5. The method of claim 4, wherein performing the simulations comprises:
obtaining parameters defining each of the simulated scenarios;
simulating use of different courses of action for each of the simulated scenarios using different selected cutoff values to generate different simulation results for each simulated scenario; and
scoring the simulation results to identify one or more optimal courses of action and one or more optimal cutoff values for each of the simulated scenarios.

6. The method of claim 5, wherein performing the simulations further comprises:
modifying the selected cutoff values based on the scoring to produce updated cutoff values; and
simulating use of the different courses of action for each of the simulated scenarios using the updated cutoff values.

7. The method of claim 1, wherein:
the current operational environment comprises a space environment; and
the one or more recommended courses of action are associated with one or more actions by at least one space-based vehicle.

8. An apparatus comprising:
at least one processing device configured to:
identify one or more characteristics associated with a current operational environment;
identify one or more simulated scenarios having one or more characteristics that are similar to or match the one or more characteristics associated with the current operational environment;
identify one or more cutoff values associated with the one or more simulated scenarios and one or more recommended courses of action associated with the one or more simulated scenarios;
use the one or more cutoff values to generate at least one notification, the at least one notification associated with the current operational environment; and
initiate presentation of the one or more recommended courses of action to at least one user or a decision engine for initiation within the current operational environment.

9. The apparatus of claim 8, wherein the at least one processing device is configured to initiate the presentation of the one or more recommended courses of action in response to determining that at least one of the one or more cutoff values has triggered the at least one notification.

10. The apparatus of claim 8, wherein the at least one processing device is further configured to dynamically update at least one of the one or more cutoff values or at least one of the one or more recommended courses of action based on one or more updated characteristics associated with the current operational environment.

11. The apparatus of claim 8, wherein the at least one processing device is further configured to perform simulations for multiple simulated scenarios to identify, for each simulated scenario, at least one recommended course of action and at least one cutoff value.

12. The apparatus of claim 11, wherein, to perform the simulations, the at least one processing device is configured to:
obtain parameters defining each of the simulated scenarios;
simulate use of different courses of action for each of the simulated scenarios using different selected cutoff values to generate different simulation results for each simulated scenario; and
score the simulation results to identify one or more optimal courses of action and one or more optimal cutoff values for each of the simulated scenarios.

13. The apparatus of claim 12, wherein, to perform the simulations, the at least one processing device is further configured to:
modify the selected cutoff values based on the scoring to produce updated cutoff values; and
simulate use of the different courses of action for each of the simulated scenarios using the updated cutoff values.

14. The apparatus of claim 8, wherein:
the current operational environment comprises a space environment; and
the one or more recommended courses of action are associated with one or more actions by at least one space-based vehicle.

15. A non-transitory computer readable medium containing instructions that when executed cause at least one processor to:
identify one or more characteristics associated with a current operational environment;
identify one or more simulated scenarios having one or more characteristics that are similar to or match the one or more characteristics associated with the current operational environment;
identify one or more cutoff values associated with the one or more simulated scenarios and one or more recommended courses of action associated with the one or more simulated scenarios;
use the one or more cutoff values to generate at least one notification, the at least one notification associated with the current operational environment; and
initiate presentation of the one or more recommended courses of action to at least one user or a decision engine for initiation within the current operational environment.

16. The non-transitory computer readable medium of claim 15, wherein the instructions when executed cause the at least one processor to initiate the presentation of the one or more recommended courses of action in response to determining that at least one of the one or more cutoff values has triggered the at least one notification.

17. The non-transitory computer readable medium of claim 15, further containing instructions that when executed cause the at least one processor to dynamically update at least one of the one or more cutoff values or at least one of the one or more recommended courses of action based on one or more updated characteristics associated with the current operational environment.

18. The non-transitory computer readable medium of claim 15, further containing instructions that when executed cause the at least one processor to perform simulations for multiple simulated scenarios to identify, for each simulated scenario, at least one recommended course of action and at least one cutoff value.

19. The non-transitory computer readable medium of claim 18, wherein the instructions that when executed cause the at least one processor to perform the simulations comprise:
instructions that when executed cause the at least one processor to:
obtain parameters defining each of the simulated scenarios;
simulate use of different courses of action for each of the simulated scenarios using different selected cutoff values to generate different simulation results for each simulated scenario; and
score the simulation results to identify one or more optimal courses of action and one or more optimal cutoff values for each of the simulated scenarios.

20. The non-transitory computer readable medium of claim 19, wherein the instructions that when executed cause the at least one processor to perform the simulations further comprise:
instructions that when executed cause the at least one processor to:
modify the selected cutoff values based on the scoring to produce updated cutoff values; and
simulate use of the different courses of action for each of the simulated scenarios using the updated cutoff values.
